(19) United States
(12) Patent Application Publication
(10) Pub. No.: US 2011/0192368 A1
(43) Pub. Date: Aug. 11, 2011

(54) METHOD AND SYSTEM FOR PROCESSING ENGINE NOISE

(75) Inventors: Christoph Becker, Olpe (DE); Klaus Steputsch, Koeln (DE)

(73) Assignee: FORD GLOBAL TECHNOLOGIES, LLC, Dearborn, MI (US)

(21) Appl. No.: 13/012,535

(22) Filed: Jan. 24, 2011

(30) Foreign Application Priority Data
Feb. 9, 2010 (DE) 10-2010-001718.3

(51) Int. Cl. F02M 35/104

(52) U.S. Cl. 123/184.21

(57) ABSTRACT

An intake system for an internal combustion engine is disclosed. The intake system may include a device for transmitting engine noise to a vehicle operator. The approach may provide higher fidelity engine noise to the vehicle operator to improve the operator's driving experience.

### RELATED APPLICATIONS

This application claims priority to German Patent Application No. 102010001718.3 entitled “Manifold Ducted Sound Symposer,” filed on Feb. 9, 2010, the entire contents of which being incorporated herein by reference.

### BACKGROUND/SUMMARY

The present description relates to transmission of noise from an air intake system of an internal combustion engine. Such a device for noise transmission in a motor vehicle is described for example in the European patent EP 1 630 789 B1. The device of EP 1 630 789 B1 comprises a housing in which a partition delimits and separates from one another two partial chambers which are separate from one another. The partition has an aperture in which a pivotable flap is arranged in a pressure-tight manner. The first partial chamber is connected to the intake system of the internal combustion engine, while the second partial chamber leads via a line to a wall of the vehicle or directly into the interior space. Sound pressure oscillations caused by the charge exchange in the intake system act in the first partial chamber and therefore on the pivotable transmission flap, which is incited to perform a pivoting movement. In the second partial chamber, the moving, that is to say oscillating transmission flap in turn leads to sound pressure oscillations which are conducted, that is to say transmitted, from here—directly or indirectly—into the vehicle interior space, and which therefore significantly co-determine the vehicle interior noise.

One characteristic of a device of the type described in EP 1 630 789 B1 is that the noises are merely transmitted, and that the noise pattern itself, in the present case the noise pattern picked off from the intake system and used, is substantially not changed. Further, the device described in EP 1 630 789 B1 may not be suitable for transmitting some more desirable engine noises to an operator of the vehicle.

The inventors herein have recognized the above-mentioned boundary conditions and have developed an intake system for an internal combustion engine having at least two cylinders, comprising: an intake manifold including at least one air inlet for each of the at least two cylinders, each of the at least one air inlets adjoining an intake line, the intake lines adjoining a chamber, the chamber merging into an overall air intake line; and an additional line branching off from the intake manifold at a distance from the overall intake line, the additional line being provided with a device for noise transmission.

By branching off an additional line from an intake manifold of an engine it is possible to transmit half-order sound pulsations to an operator even on basically symmetric intake manifolds. The half-order sound pulsations may provide the operator with an increased perception of a sporty vehicle. Accordingly, the operator's driving experience may be enhanced.

The present description may provide several advantages. In particular, the approach may improve an operator's perception of vehicle performance. Further, the approach may be used during selected operating conditions so as to not become an annoyance to the operator. Further still, the approach may amplify engine noise so that it may be more easily perceived by the operator.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an engine and intake system;

FIG. 2 shows a schematic depiction of an intake system according to the prior art;

FIG. 3 shows a schematic depiction of an intake system of the present description; and

FIG. 4 shows a high level flowchart of a method for operating an air intake system.

### DETAILED DESCRIPTION

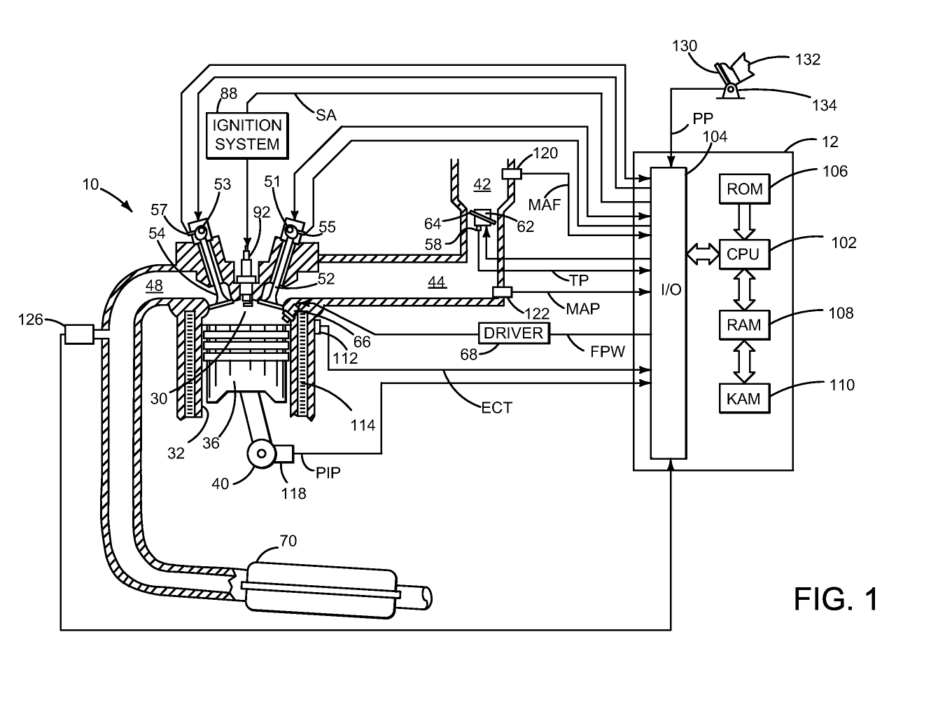

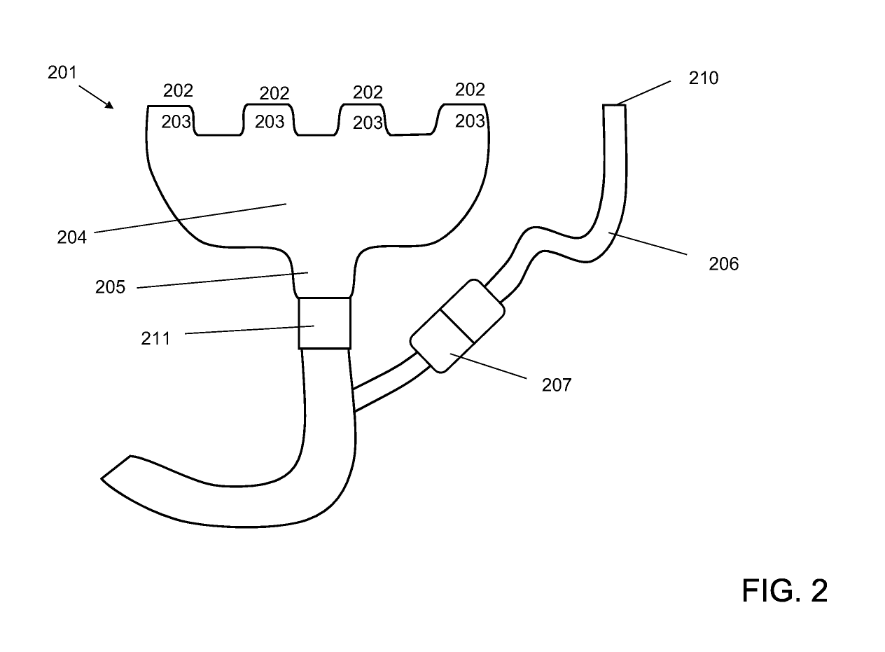

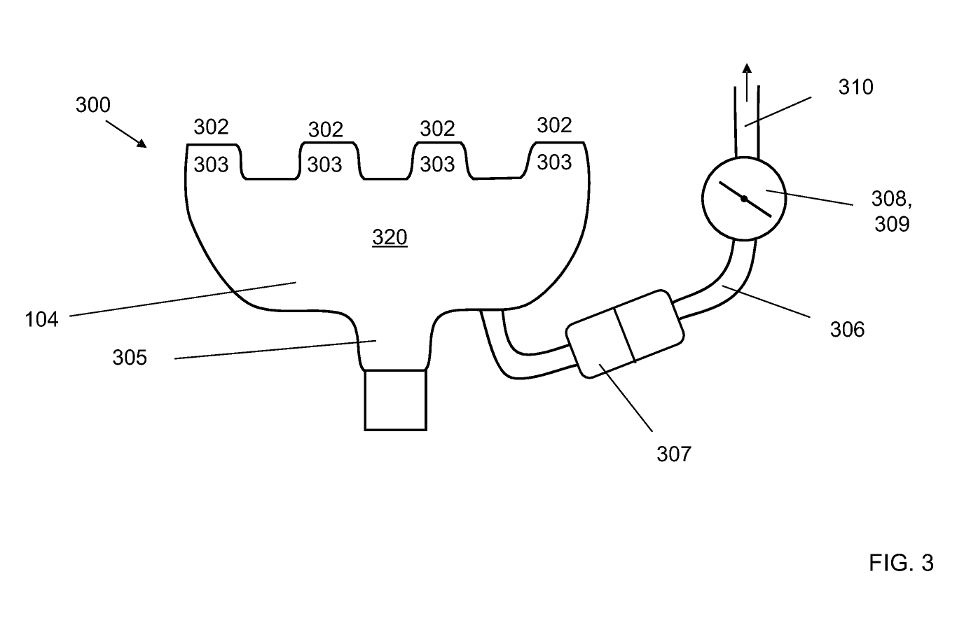

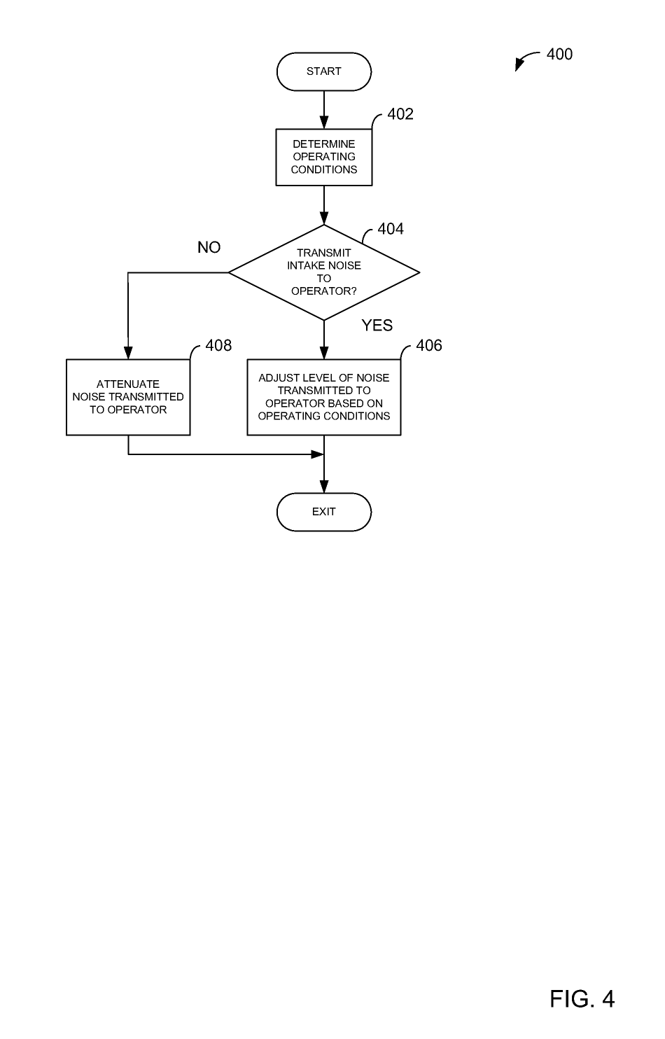

The present description is related to providing audible engine noise to a vehicle operator. FIG. 1 shows one example engine system for providing engine noise to a vehicle operator. FIG. 2 shows a schematic depiction of a prior art system. FIG. 3 shows a schematic depiction of one example of the present description. FIG. 4 shows a method for operating an intake system for providing engine noise to a vehicle operator.

Initially, development work within the context of vehicle acoustics focused solely on noise reduction. Here, the focus was initially on the internal combustion engine as the dominant noise source of the motor vehicle and subsequently also on the auxiliary units as noise sources which make a significant contribution to the overall noise emission.

It is increasingly sought to not only reduce the noise generated by the motor vehicle but rather also influence or utilize said noise in a targeted fashion, which is generally also referred to as noise design or sound design. This development work is motivated by the realization that the purchase decision of a potential customer when buying a vehicle is influenced not insignificantly by the noise of the internal combustion engine and of the vehicle. The driver of a sports car thus prefers a vehicle or an engine whose noise emphasizes the sporty character of the vehicle.

As noise sources in a motor vehicle, a basic distinction can be made between airborne sound sources and body-borne sound sources. The airborne sound sources include for example the intake noise, the exhaust orifice noise and the fan noise of the cooler, whereas the body-borne sound sources include in particular the drivetrain which is attached to the body via the engine mounts, and the rolling tires.

The development work with regard to the noise reduction of the engine has led to a steady decrease in the noise component of the engine, that is to say the actual engine noise. Modern motor vehicles are generally equipped with internal combustion engines with very high levels of running smoothness, the operating noise of which is almost imperceptible in the vehicle interior space or is under some circumstances even drowned out by other noises such as the noise of the rolling tires, the ventilation or the like.

Taking into consideration the fact that a driver prefers and also wishes to perceive a sporty engine operating noise, it can be expedient to transmit the operating noise of the internal combustion engine audibly into the interior space of the motor vehicle, for which purpose—as already mentioned in the introduction—use can be made of a device for noise transmission.

Against this background, it is an object of the present description to provide an intake system according to the preamble of claim 1, by means of which the disadvantages known according to the prior art are overcome and which in particular makes it possible to provide a sporty engine operating noise in the passenger compartment.

It is a further partial object of the present description to specify a method for operating an intake system of said type. The first partial object is achieved by means of an intake system for an internal combustion having at least two cylinders, with each cylinder having at least one inlet opening for the supply of fresh air, with each inlet opening being adjoined by an intake line, with the intake lines of at least two cylinders merging upstream to form an overall intake line, such that an intake manifold is formed, and with an additional line being provided in which a device for noise transmission is arranged, which intake system is characterized in that the additional line branches off from the intake manifold at a distance from the overall intake line.

The fact that the branch of the additional line has been relocated in relation to the prior art from the overall intake line to the intake manifold has the effect that, in the sound pressure oscillation at the inlet into the additional line, broken down by means of Fourier analysis into its harmonic components, the pressure oscillations of the integer engine orders do not dominate, but rather the half-order pressure oscillations have considerably greater amplitudes and contribute a notable proportion to the sound pressure in the line.

In the intake system according to the description, the sound pressure levels of the pressure oscillations of the integer engine orders and the sound pressure levels of the half-order pressure oscillations do not differ to the same extent as in the intake systems known from the prior art. Consequently, the half-order pressure oscillations required for a sporty engine operating noise make up a greater proportion of the overall pressure level of the sound pressure oscillation.

The branch, which is arranged on the intake manifold at a distance from the overall intake line, of the additional line leads to this effect which is advantageous for the operating noise, because the irregular arrangement of the additional line or of its branch from the intake system in relation to the individual cylinders has the effect that, as a result of the different path lengths on the way from the cylinder to the branch, the half-engine-order pressure oscillations do not attenuate or completely eliminate one another.

The first object on which the description is based, specifically that of providing an intake system of the generic type which makes it possible to provide a sporty engine operating noise in the passenger compartment, is thereby achieved.

The additional line leads either directly into the vehicle interior space or is conducted into a cavity adjacent to the interior space or towards a wall which delimits the interior space, such that the sound pressure oscillations leaving the open end of the line are either transmitted directly into the interior space and propagate therein, or else incite a wall to perform body-borne sound oscillations, which wall then radiates the body-borne sound again via its surfaces, and thereby indirectly transmits said sound onward, as airborne sound. Further advantageous examples of the intake system will be described below, also in connection with the subclaims.

Examples of the intake system are advantageous in which the distance between the additional line and the overall intake line is greater than the diameter of an inlet opening of a cylinder, preferably greater than half of the diameter of a cylinder, or preferably greater than the diameter of a cylinder, with the distance being defined by the spacing between the central axis of the overall intake line and the central axis of the additional line.

The three examples specified above, which without exception relate to the magnitude of the distance between the additional line and the overall intake line, and the gradation thereof are based on the assumption that the half-engine-order pressure oscillations are attenuated to an ever lesser extent with increasing distance. It could be concluded from this that, the greater the distance, the more advantageous this is for noise design. This however cannot apply without restrictions for all possible examples of the intake system.

Whether the half-engine-order pressure oscillations attenuate or completely eliminate one another on the way from the cylinder to the branch is dependent on a multiplicity of further factors in addition to the distance between the additional line and the overall intake line, in particular the number of cylinders, the ignition sequence of said cylinders, the design of the intake manifold, that is to say in particular whether a symmetrical or asymmetrical manifold is used, the number of intake manifolds and the way in which the intake lines merge to form a manifold.

Examples of the intake system are advantageous in which the intake manifold is of symmetrical design. As already stated in conjunction with the description of the prior art, the problem of the dominance of the integer engine orders is particularly pronounced in intake systems with symmetrically designed intake manifolds.

For this reason, it is particularly advantageous for the intake system according to the description to be applied to symmetrically designed intake manifolds, that is to say for intake systems with symmetrical intake manifolds to be designed in the manner according to the description, specifically in such a way that the additional line branches off from the symmetrical intake manifold at a distance from the overall intake line.

The present description however fundamentally also encompasses examples in which the intake manifold is of asymmetrical design. Examples of the intake system are advantageous in which a noise-damping element is provided in the additional line.

Even though the driver, in particular the driver of a sports car, basically prefers a noise which emphasizes the sporty character of the vehicle or suggests a sporty character, the driver specifically does not wish to perceive such a noise in the vehicle interior space at some selected operating points, for example at idle or in overrun operation. In such operating modes, when the vehicle is being decelerated by means of engine braking or is at a standstill at a red light, the driver considers a sporty noise, which is associated with dynamics, to be unsuitable, and therefore unpleasant.

For said reasons, it is advantageous to provide a noise-damping element, by means of which the pressure oscillations in the additional line, and therefore the noise, can be damped when required. In this connection, examples of the intake system are advantageous in which the noise-damping element is arranged downstream in a direction of noise flow of the device for noise transmission. In this connection, examples of the intake system are advantageous in which the noise-damping element is arranged upstream of the device for noise transmission. The two abovementioned examples differ in that, in the case of an element arranged upstream of the device for noise transmission, the exciter vibration proceeding from the intake manifold is dampened, whereas in the case of an arrangement of the element downstream of the device for noise transmission, the transmitted and thereby forced vibration is dampened.

Which of the two variants is used, that is to say realized, is dependent on the present individual situation, in particular on the space availability, that is to say the packaging, on the expected repercussion on the engine controller, and on the type of element used for noise transmission, which may basically be an active or passive element. In this connection, examples of the intake system are particularly advantageous in which the noise-damping element is an actively controllable element. The element may be electrically, hydraulically, pneumatically, mechanically or magnetically controllable, preferably by means of the engine controller.

An actively controllable element may be actuated when required, that is to say at any time, and in any desired way, preferably by means of an engine controller, the engine controller including instructions for operating the intake system, specifically regardless of the present pressure or flow conditions at the installation location in the additional line, and independently of the operating parameters of the internal combustion engine in general, whereas a passive element is self-controlling or positively controlled corresponding to a fixed characteristic curve, for example by means of the pressure in the additional line, which varies and thereby adjusts the element.

For example, if a passive element is arranged downstream of the device for noise transmission, a control line must be provided which acts on the element with the line pressure upstream of the device. Examples are advantageous in which the noise-damping element is designed so as to be switchable, that is to say adjustable, in a two-stage, multi-stage or continuous fashion. However, the wider the range of adjustment possibilities of the element, the more expensive the element and the associated controller may be. On the other hand, however, the bandwidth in the adjustment of the degree of damping of the pressure oscillations is also increased, and the possibilities for noise design, that is to say for the generation of the preferred vehicle interior noise, are widened, with a continuously adjustable element being particularly advantageous.

From that which has been stated above, it emerges that examples of the intake system are advantageous in which the noise-damping element is designed to be switchable in a two-stage manner. An element which is switchable in a two-stage manner is characterized in that it can only change between two switching positions or states.

One variant of an element which is switchable in a two-stage manner is formed for example by an element which, in a first switching position, opens up the additional line and, in a second switching position, closes off or blocks said line. While the pressure oscillations are then transmitted unhindered, that is to say undampened, via the line in the first switching position, the transmission of the pressure oscillations, and therefore of the noise, is prevented, that is to say substantially dampened, in the second switching position.

Examples of the intake system are advantageous in which the noise-dampening element is designed to be continuously adjustable. With a continuously adjustable damper element, it is possible to vary and consequently model the pressure oscillation in the additional line, and therefore the noise which is transmitted into the vehicle interior space, to the widest possible extent.

Examples of the intake system are advantageous in which the noise-damping element is an actively adjustable flap. In the variant which is switchable in a two-stage fashion, said flap can then be switched between an open position and a closed position, with the flap either opening up or closing off the additional line. If the flap is continuously adjustable, a more or less large cross section of the additional line is opened up as a function of the present flap position. Examples of the intake system are advantageous in which the noise-damping element and the device for noise transmission form a common, integral component.

Such an integral component could be formed through the use of suitable materials. For example, the diaphragm of the device for noise transmission described in EP 1 630 789 B1, by means of which diaphragm a gap on the transmission flap is closed off in a pressure-tight fashion, could be produced from a material which changes its stiffness, preferably in a continuously variable fashion, upon activation, for example by means of an electrical current. A fixed diaphragm would prevent a pivoting movement of the flap and, in this way, would prevent a transmission of the pressure oscillations, whereas a flexible, soft diaphragm permits a transmission. Examples of the intake system may however also be advantageous in which the device for noise transmission is designed so as to amplify noise. Examples of the intake system are advantageous in which a throttle is arranged in the overall intake line.

The throttle flap serves for load control. By adjusting the throttle flap, the pressure of the intake air downstream of the throttle flap can be reduced to a greater or lesser extent. The further the throttle flap is closed, that is to say the more the flap blocks the intake section, the greater the pressure loss of the intake air is across the throttle flap, and the lower the pressure of the intake air is downstream of the throttle flap, that is to say upstream of the inlet openings into the combustion chamber. For a constant combustion chamber volume, it is possible in this way for the air mass, that is to say the quantity, to be set by means of the pressure of the intake air. A disadvantage of quantity regulation is that low loads require a high degree of throttling and a large pressure reduction in the intake system, which is thermodynamically unfavorable.

Examples of the intake system are advantageous in which the overall intake line has arranged in it a supercharger, that is to say a compressor, by means of which the fresh intake air is compressed. The supercharging may be performed using a mechanical supercharger or an exhaust-gas turbocharger. For supercharging, modern internal combustion engines generally use an exhaust-gas turbocharger in which a compressor and a turbine are arranged on the same shaft, with the hot exhaust-gas flow being supplied to the turbine and expanding in said turbine with a release of energy, as a result of which the shaft is set in rotation. The energy supplied by the exhaust-gas flow to the turbine and ultimately to the shaft is used for driving the compressor which is likewise arranged on the shaft. The compressor feeds and compresses the charge air supplied to it, as a result of which supercharging of the cylinders is attained.

The turbocharging process intensely dampens the acoustic order pattern in the intake system upstream of the turbine, which opposes the formation of a sporty driving noise. Specifically with supercharged internal combustion engines, however, the driver expects an operating noise which emphasizes the sporty character of the vehicle.

The second partial object is achieved by means of a method for operating an intake system of an abovementioned type having a noise-damping element which is arranged in the additional line and is actively controllable, which method is characterized in that the noise-damping element is actuated by means of an engine controller in order to adjust the damping of the sound pressure oscillations propagating in the additional line.

That which has been stated above in connection with the intake system according to the invention also applies to the method according to the invention, for which reason reference is made to the description of the various examples.

If an actively adjustable flap which can be adjusted in a continuous fashion between an open position and a closed position serves as a noise-damping element, method variants are advantageous in which the flap is adjusted in the direction of the closed position in order to more intensely dampen the sound pressure oscillations propagating in the additional line, and is adjusted in the direction of the open position in order to less intensely dampen the sound pressure oscillations propagating in the additional line.

Method variants are advantageous in which the noise-damping element for damping the propagating sound pressure oscillations is activated and actuated only at selected predefined operating points of the internal combustion engine, with it being possible for the predefined operating points to be idle operation, overrun operation and/or lower part-load operation of the internal combustion engine.

The description will be described in more detail below on the basis of an exemplary embodiment according to FIG. 3. FIG. 2 has already been explained in conjunction with the description of the prior art.

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. Alternatively, one or more of the intake and exhaust valves may be operated by an electromechanically controlled valve coil and armature assembly. The position of intake cam 51 may be determined by intake cam sensor 55. The position of exhaust cam 53 may be determined by exhaust cam sensor 57.

Fuel injector 66 is shown positioned to inject fuel directly into cylinder 30, which is known to those skilled in the art as direct injection. Alternatively, fuel may be injected to an intake port, which is known to those skilled in the art as port injection. Fuel injector 66 delivers liquid fuel in proportion to the pulse width of signal FPW from controller 12. Fuel is delivered to fuel injector 66 by a fuel system (not shown) including a fuel tank, fuel pump, and fuel rail (not shown). Fuel injector 66 is supplied operating current from driver 68 which responds to controller 12. In addition, intake manifold 44 is shown communicating with optional electronic throttle 62 which adjusts a position of throttle plate 64 to control air flow from air intake 42 to intake manifold 44. In one example, a low pressure direct injection system may be used, where fuel pressure can be raised to approximately 20-30 bar. Alternatively, a high pressure, dual stage, fuel system may be used to generate higher fuel pressures.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing force applied by foot 132; a measurement of engine manifold pressure (MAP) from pressure sensor 122 coupled to intake manifold 44; an engine position sensor from a Hall effect sensor 118 sensing crankshaft 40 position; a measurement of air mass entering the engine from sensor 120; and a measurement of throttle position from sensor 58. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

In some examples, the engine may be coupled to an electric motor/battery system in a hybrid vehicle. The hybrid vehicle may have a parallel configuration, series configuration, or variation or combinations thereof. Further, in some examples, other engine configurations may be employed, for example a diesel engine.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

Referring now to FIG. 2, a schematic diagram of the prior art is depicted. In the prior art, an intake system of the above-stated type, or the device for noise transmission with which said intake system is equipped, serves together with the additional line to transmit the operating noise of the internal combustion engine audibly into the interior space of the motor vehicle.

A characteristic of a device of the type describe in EP 1 630 789 B1 is that the noises are merely transmitted, and the noise pattern itself, in the present case the noise pattern picked off from the intake system and used, is substantially not changed.

According to the prior art, the device 207 for noise transmission is arranged in an additional line 206 which branches off from the overall intake line 205 of the intake manifold 204, as can also be seen from FIG. 2.

FIG. 2 illustrates a conventional intake system 2 for an internal combustion engine having four cylinders 202 in an in-line arrangement. Each cylinder 202 has two inlet openings for the supply of fresh air, with the inlet openings being adjoined by intake lines 203 which merge upstream to form an overall intake line 205, such that an intake manifold 204 is formed. A throttle element 211 for load control is arranged in the overall intake line 205. Additional line 206 is positioned upstream of throttle element 211 according to the direction of air flow to engine cylinders 202.

Proceeding from steady-state operation of the internal combustion engine, which is characterized by a constant rotational speed and a constant load, the sound pressure oscillation in the additional line can be broken down into its harmonic components by means of Fourier analysis.

Here, the sound pressure oscillation is composed of a constant pressure and a multiplicity of harmonically varying pressures which have different pressure amplitudes, that is to say sound pressure levels, and frequencies, that is to say vibration numbers. The ratio of the vibration number nᵢ of each harmonic to the rotational speed n of the crankshaft or of the engine is referred to as the order i of the harmonic.

A disadvantage of the intake system 201 shown in FIG. 2 is that, in the overall intake line 205 and therefore at the inlet into the additional line 206, the pressure oscillations of the integer engine orders dominate, that is to say have significantly greater sound pressure levels, whereas pressure oscillations of half-orders are of secondary significance on account of the low sound pressure level. Because the noise pattern is substantially not changed, the pressure oscillations of the integer engine orders likewise dominate at the opening-out point 210 of the additional line 206.

The fact that the pressure oscillations of the integer engine orders dominate in the intake system illustrated in FIG. 2 is also based on the fact that the intake manifold is of symmetrical design, and consequently the intake lines between the inlet opening at the cylinder and the common overall intake line are of equal lengths in a paired fashion, and the half-order pressure oscillations are superposed on the way from the cylinder to the overall intake line, in such a way that said half-order pressure oscillations attenuate or completely eliminate one another.

However, tests have shown that half-order pressure oscillations are of vital importance for a sporty engine operating noise. Therefore, it may be desirable to construct an intake system that has the capability of transmitting half-order pressure oscillations to an operator without attenuating the half-order pressure oscillations as compared to the integer order pressure oscillations.

Referring now to FIG. 3, a schematic depiction of an intake system of the present description is shown. In particular, intake system 300 for an internal combustion engine having four cylinders 302 in an in-line arrangement is shown. Each cylinder 302 has two inlet openings for the supply of fresh air, with each inlet opening being adjoined by an intake line 303 and with the intake lines 303 of the four cylinders 302 merging upstream to form an overall intake line 305, such that an intake manifold 104 is formed. Intake manifold 104 may include a chamber 320 leading to intake lines 303 from overall intake line 305.

An additional line 306 is provided in which a device for noise transmission 307 is arranged. The open end, that is to say the opening-out point 310, of the additional line 306 is guided into the vehicle interior space or is conducted into a cavity adjacent to the interior space or towards a wall which delimits the interior space, such that the sound pressure oscillations leaving the opening-out point 310 are either transmitted directly into the interior space and propagate therein, or else incite a wall to perform body-borne sound oscillations, which wall then radiates the body-borne sound again via its surfaces, and thereby indirectly transmits said sound onward, as airborne sound.

In the intake system 300 illustrated in FIG. 3, the additional line 306 branches off from the intake manifold 104, specifically at a distance from the overall intake line 305. Said irregular arrangement of the additional line 306 with respect to the individual cylinders 302 has the effect that the half-engine-order pressure oscillations do not attenuate or eliminate one another on the way from the cylinders 302 to the branch of the additional line 306. An intake system 300 of said type makes it possible to provide a sporty engine operating noise in the passenger compartment.

Furthermore, the intake system 300 illustrated in FIG. 3 is equipped with a noise-damping element 308 in the form of a continuously adjustable flap 309. The flap 309 is arranged downstream of the device for noise transmission 307 and is continuously adjustable between an open position and a closed position. An adjustment of the flap 309 in the direction of the closed position generates intensified damping of the sound pressure oscillations which previously were transmitted and propagated in the additional line. If, in contrast, the flap 309 is adjusted in the direction of the open position, the propagating sound pressure oscillations are less intensely dampened.

Referring now to FIG. 4, a high level flowchart of a method for operating an air intake system is shown. Method 400 is executable as instructions for an engine control such as controller 12 of FIG. 1.

At 402, method 400 determines operating conditions. Operating conditions may include but are not limited to engine speed, engine load, vehicle speed, engine temperature, and engine torque demand. Operating conditions may be determined via sensors and actuators or may be calculated. Method 400 proceeds to 404 after operating conditions are determined.

At 404, method 400 judges whether or not to transmit noise to a vehicle operator. In one example, engine noise is transmitted to an operator during periods where engine speed and engine torque demand exceed a predetermined engine speed threshold and an engine torque demand threshold. Method 400 may judge not to transmit noise to a vehicle operator when engine speed and engine torque demand are less than the threshold engine speed and threshold engine torque demand. Further, the conditions where noise is transmitted to the vehicle driver may vary as operating conditions vary. For example, the engine torque demand threshold where noise is transmitted to the vehicle operator may increase for lower engine temperatures. Since engine noise may increase at lower engine temperatures, it may be less desirable to transmit engine noise at similar torque demand as during warm engine operating conditions. In other examples, a position of an operator selectable switch may be the basis for judging whether or not to transmit noise to a vehicle operator. If method 400 judges to transmit engine noise to the vehicle operator, method 400 proceeds to 406. Otherwise, method 400 proceeds to 408.

At 406, method 400 adjusts a noise dampening element in response to operating systems so that noise is transmitted to the vehicle operator. In one example, a position of a noise-dampening device is adjusted so that at least some noise is transmitted to the vehicle operator from the intake system. In particular, the flap opening amount may be increased in response to a request to increase noise transmitted to a vehicle operator. The noise may be acquired from a position within the intake manifold downstream of a throttle and an overall air intake passage. In one example, noise may be acquired from a location in the intake manifold as illustrated in FIG. 3. If operating conditions change so that it may be desirable to transmit less noise to the vehicle operator, the flap opening amount may be decreased in response to a request to decrease noise transmitted to a vehicle operator. Method 400 proceeds to exit after an amount of noise transmitted to the vehicle operator is adjusted.

At 408, method 400 adjusts an amount of noise transmitted to a vehicle operator such that the noise attenuation level is increased. In one example, a noise-dampening flap is set to a fully closed position so that the noise-dampening element is at substantially full noise attenuation capacity. In other examples, the noise-dampening flap may be set to a position that reduces noise transmission below a threshold level that is higher than a maximum attenuation level of the noise-dampening element. Method 400 proceeds to exit after the noise-dampening element has been adjusted to reduce noise transmitted to the vehicle operator.

As will be appreciated by one of ordinary skill in the art, the methods described in FIG. 4 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used.

This concludes the description. The reading of it by those skilled in the art would bring to mind many alterations and modifications without departing from the spirit and the scope of the description. For example, single cylinder, I2, I3, I4, I5, V6, V8, V10, V12 and V16 engines operating in natural gas, gasoline, diesel, or alternative fuel configurations could use the present description to advantage.

1. An intake system for an internal combustion engine having at least two cylinders, comprising:
an intake manifold including at least one air inlet for each of the at least two cylinders, each of the at least one air inlets adjoining an intake line, the intake lines adjoining a chamber, the chamber merging into an overall air intake line; and
an additional line branching off from the intake manifold at a distance from the overall intake line, the additional line being provided with a device for noise transmission.

2. The intake system of claim 1, where the distance between the additional line and the overall intake line is greater than half of the diameter of one of the at least two cylinders.

3. The intake system of claim 1, where the intake manifold is symmetric with respect to air inlets.

4. The intake system of claim 1, further comprising a noise-dampening element in the addition line.

5. The intake system of claim 4, where the noise-dampening element is arranged downstream of the device for noise transmission.

6. The intake system of claim 4, where the noise-dampening element is arranged upstream of the device for noise transmission.

7. The intake system of claim 4, where the noise-dampening element is an actively controllable element.

8. The intake system of claim 7, where the noise-dampening element is configured to be two-stage switchable.

9. The intake system of claim 7, where the noise-dampening element is configured to be continuously adjustable.

10. The intake system of claim 9, where the noise-dampening element is an actively adjustable flap.

11. The intake system of claim 10, where the device for noise transmission amplifies noise.

12. The intake system of claim 11, where a throttle is arranged in the overall intake line.

13. An intake system for an internal combustion engine having at least two cylinders, comprising:
an intake manifold including at least one air inlet for each of the at least two cylinders, each of the at least one air inlets adjoining an intake line, the intake lines adjoining a chamber, the chamber merging into an overall air intake line;
additional line branching off from the chamber at a distance from the overall intake line of a greater than a diameter of the least one air inlet, the additional line being provided with a device for noise transmission; and
a controller, the controller including instructions for attenuating noise from the device for noise transmission.

14. The system of claim 13, where the controller includes further instructions for continuously adjusting a noise-dampening element.

15. The system of claim 14, where the noise-dampening element is an actively adjustable flap.

16. A method for operating an intake system, comprising:
adjusting a noise-dampening element arranged in an additional line coupled to an intake manifold at a chamber, the chamber having an overall intake line and at least one air inlet for each of at least two cylinders of an internal combustion engine.

17. The method of claim 16, where the noise-dampening element includes a flap, where the flap is adjusted between an open position and a closed position, where the flap is adjusted in a direction of a closed position in order to more intensely dampen sound pressure oscillations propagating in the additional line.

18. The method of claim 17, further comprising adjusting the flap in a direction of an open position in order to less intensely dampen the sound pressure oscillations propagating in the additional line.

19. The method of claim 17, where the noise-damping element is activated and actuated only at selected predefined operating points of the internal combustion engine.

20. The method of claim 19, where the selected predefined operating point include at least one of idle operation, overrun operation, and lower part-load operation of the internal combustion engine.
